(19) United States
(12) Patent Application Publication
(10) Pub. No.: US 2023/0319787 A1
(43) Pub. Date: Oct. 5, 2023

(54) TIME DOMAIN RESOURCE ALLOCATION FOR A PHYSICAL SIDELINK FEEDBACK CHANNEL WITH CARRIER AGGREGATION

(71) Applicant: Samsung Electronics Co., Ltd., Suwon-si (KR)

(72) Inventors: Carmela Cozzo, San Diego, CA (US); Hongbo Si, Plano, TX (US); Emad N. Farag, Flanders, NJ (US)

(21) Appl. No.: 18/186,830

(22) Filed: Mar. 20, 2023

Related U.S. Application Data
(60) Provisional application No. 63/326,570, filed on Apr. 1, 2022.

(51) Int. Cl. H04W 72/02; H04W 72/0453; H04L 1/1812

(52) U.S. Cl. CPC H04W 72/02; H04W 72/0453; H04L 1/1812

(57) ABSTRACT

Apparatuses and methods for time domain resource allocation for a physical sidelink feedback channel (PSFCH) with carrier aggregation are provided. A method of a user equipment (UE) includes receiving a set of configurations from a higher layer and a carrier indicator field in a physical channel. The method further includes identifying, based on the set of configurations, a resource pool including resource blocks (RBs) for transmission of PSFCHs; identifying, based on the set of configurations, a first carrier frequency from a set of carrier frequencies based on the carrier indicator field; and determining a first set of RBs from the resource pool for transmission of a first PSFCH in the first carrier frequency. The method further includes determining a first transmission occasion for the first PSFCH and transmitting the first PSFCH in the first transmission occasion using the first set of RBs in the first carrier frequency.

### CROSS-REFERENCE TO RELATED APPLICATION AND CLAIM OF PRIORITY

This application claims priority under 35 U.S.C. § 119(e) to U.S. Provisional Patent Application No. 63/326,570 filed on Apr. 1, 2022. The above-identified provisional patent application is hereby incorporated by reference in its entirety.

### TECHNICAL FIELD

The present disclosure relates generally to wireless communication systems and, more specifically, to time domain resource allocation for a physical sidelink feedback channel (PSFCH) with carrier aggregation (CA).

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to apparatuses and methods for time domain resource allocation for physical PSFCH with CA.

In one embodiment, a user equipment (UE) in a wireless communication system is provided. The UE includes a transceiver configured to receive a set of configurations from a higher layer and a carrier indicator field in a physical channel. The carrier indicator field enables an operation with a set of carrier frequencies. The UE further includes a processor operably coupled to the transceiver. The processor is configured to identify, based on the set of configurations, a resource pool including resource blocks (RBs) for transmission of PSFCHs, identify, based on the set of configurations, a first carrier frequency from the set of carrier frequencies based on the carrier indicator field, determine, based on the set of configurations, a first set of RBs from the resource pool for transmission of a first PSFCH in the first carrier frequency, and determine a first transmission occasion for the first PSFCH. The transceiver is further configured to transmit the first PSFCH in the first transmission occasion using the first set of RBs in the first carrier frequency.

In another embodiment, a method of UE in a wireless communication system is provided. The method includes receiving a set of configurations from a higher layer and a carrier indicator field in a physical channel. The carrier indicator field enables an operation with a set of carrier frequencies. The method further includes identifying, based on the set of configurations, a resource pool including RBs for transmission of PSFCHs; identifying, based on the set of configurations, a first carrier frequency from the set of carrier frequencies based on the carrier indicator field; and determining, based on the set of configurations, a first set of RBs from the resource pool for transmission of a first PSFCH in the first carrier frequency. The method further includes determining a first transmission occasion for the first PSFCH and transmitting the first PSFCH in the first transmission occasion using the first set of RBs in the first carrier frequency.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIGS. 4 and 5 illustrate example wireless transmit and receive paths according to embodiments of the present disclosure;

FIG. 6 illustrates a resource pool in Rel-16 NR V2X according to embodiments of the present disclosure;

FIG. 7 illustrates a time domain resource determination for physical sidelink feedback channel (PSFCH) according to embodiments of the present disclosure;

FIG. 8 illustrates frequency domain resource determination for PSFCH according to embodiments of the present disclosure;

FIG. 9 illustrates an example of PSFCH transmission occasions in a slot according to embodiments of the present disclosure;

FIG. 10 illustrates an example of PSFCH transmission occasions over a period of 4 slots for two carriers according to embodiments of the present disclosure;

FIG. 11 illustrates an example of PSFCH transmission occasions in a period corresponding to transmission on a carrier of multiple carriers according to embodiments of the present disclosure;

FIG. 12 illustrates an example of physical sidelink shared channel (PSSCH) and corresponding PSFCH with two carriers according to embodiments of the present disclosure;

FIG. 13 illustrates an example of collided PSFCH TX occasions associated to PSSCHs that are transmitted on different occasions according to embodiments of the present disclosure; and

FIG. 14 illustrates an example of a method for operating a user equipment according to embodiments of the present disclosure.

### DETAILED DESCRIPTION

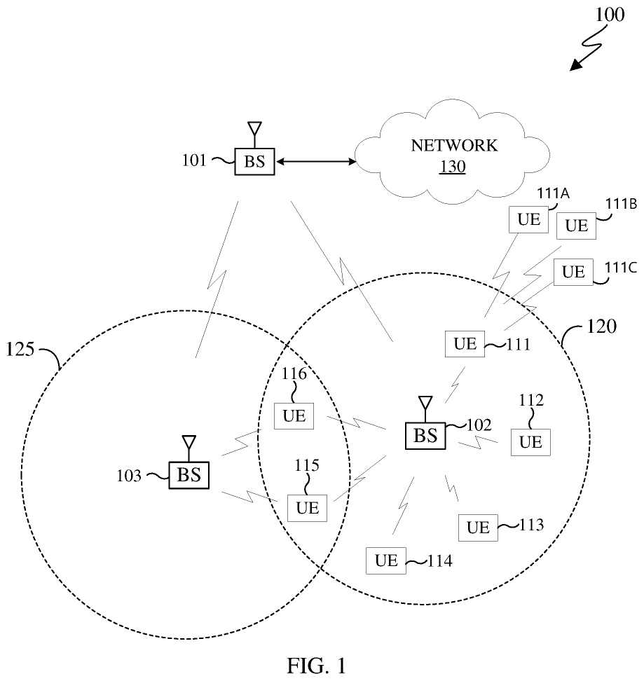

FIGS. 1 through 14, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged system or device.

The following documents and standards descriptions are hereby incorporated by reference into the present disclosure as if fully set forth herein: 3GPP TS 38.211 v17.0.0, “NR, Physical Channels and Modulation” (herein “REF 1”); 3GPP TS 38.212 v17.0.0, “NR, Multiplexing and channel coding” (herein “REF 2”); 3GPP TS 38.213 v17.0.0, “NR, Physical Layer Procedures for Control” (herein “REF 3”); 3GPP TS 38.214 v17.0.0; “NR, Physical Layer Procedures for Data” (herein “REF 4”); and 3GPP TS 38.331 v16.7.0; “NR, Radio Resource Control (RRC) Protocol Specification” (herein “REF 5”).

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

To meet the demand for wireless data traffic having increased since deployment of 4G communication systems, and to enable various vertical applications, 5G/NR communication systems have been developed and are currently being deployed.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands. To decrease propagation loss of the radio waves and increase the transmission distance, the beamforming, massive multiple-input multiple-output (MIMO), Full Dimensional MIMO (FD-MIMO), array antenna, an analog beam forming, large-scale antenna techniques are discussed in 5G communication systems.

In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (CoMP), reception-end interference cancellation and the like.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

In another example, the UE 116 may be within network coverage and the other UE may be outside network coverage (e.g., UEs 111A-111C). In yet another example, both UE are outside network coverage. In some embodiments, one or more of the gNBs 101-103 may communicate with each other and with the UEs 111-116 using 5G/NR, LTE, LTE-A, WiMAX, WiFi, or other wireless communication techniques. In some embodiments, the UEs 111-116 may use a device to device (D2D) interface called PC5 (e.g., also known as sidelink at the physical layer) for communication.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for supporting time domain resource allocation for physical PSFCH with CA. In certain embodiments, one or more of the BSs 101-103 include circuitry, programing, or a combination thereof for supporting time domain resource allocation for physical PSFCH with CA.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

As discussed in greater detail below, the wireless network 100 may have communications facilitated via one or more devices (e.g., UEs 111A to 111C) that may have a SL communication with the UE 111. The UE 111 can communicate directly with the UEs 111A to 111C through a set of SLs (e.g., SL interfaces) to provide sideline communication, for example, in situations where the UEs 111A to 111C are remotely located or otherwise in need of facilitation for network access connections (e.g., BS 102) beyond or in addition to traditional fronthaul and/or backhaul connections/interfaces. In one example, the UE 111 can have direct communication, through the SL communication, with UEs 111A to 111C with or without support by the BS 102. Various of the UEs (e.g., as depicted by UEs 112 to 116) may be capable of one or more communication with their other UEs (such as UEs 111A to 111C as for UE 111).

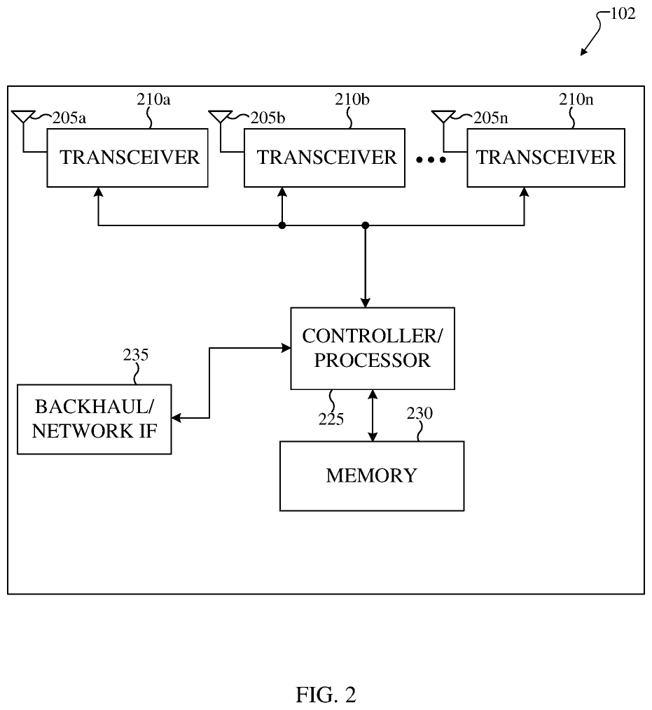

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for supporting time domain resource allocation for a PSFCH with CA. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

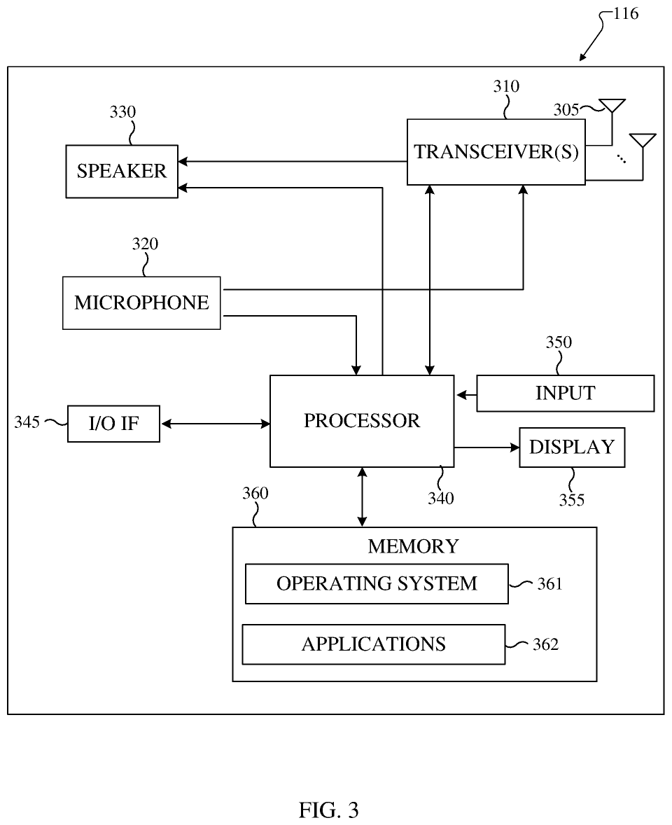

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. As another example, the processor 340 could support methods for supporting time domain resource allocation for a PSFCH with CA. In some embodiments, the processor 340 includes at least one microprocessor or microcontroller.

The processor 340 is also capable of executing other processes and programs resident in the memory 360. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

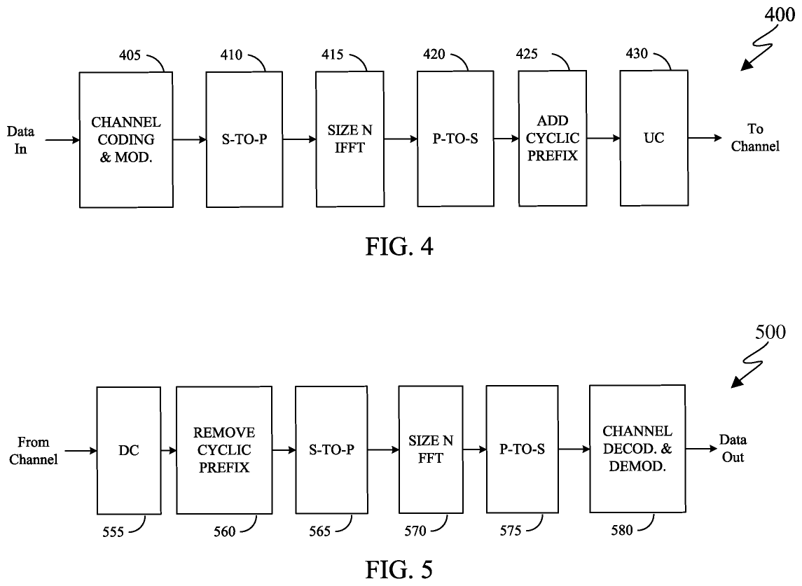

FIG. 4 and FIG. 5 illustrate example wireless transmit and receive paths according to this disclosure. In the following description, a transmit path 400, of FIG. 4, may be described as being implemented in a BS (such as the BS 102), while a receive path 500, of FIG. 5, may be described as being implemented in a UE (such as a UE 116) or vice versa. In various embodiments, the receive path 500 can be implemented in a first UE and that the transmit path 400 can be implemented in a second UE and may communicate with each other via a SL. In some embodiments, the receive path 500 is configured to support time domain resource allocation for physical PSFCH with CA as described in embodiments of the present disclosure.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the BS 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the BS 102 arrives at the UE 116 after passing through the wireless channel, and reverse operations to those at the BS 102 are performed at the UE 116.

As illustrated in FIG. 5, the down-converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the BSs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the BSs 101-103 and may implement the receive path 500 for receiving in the downlink from the BSs 101-103.

Each of the components in FIG. 4 and FIG. 5 can be implemented using hardware or using a combination of hardware and software/firmware. As a particular example, at least some of the components in FIGS. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

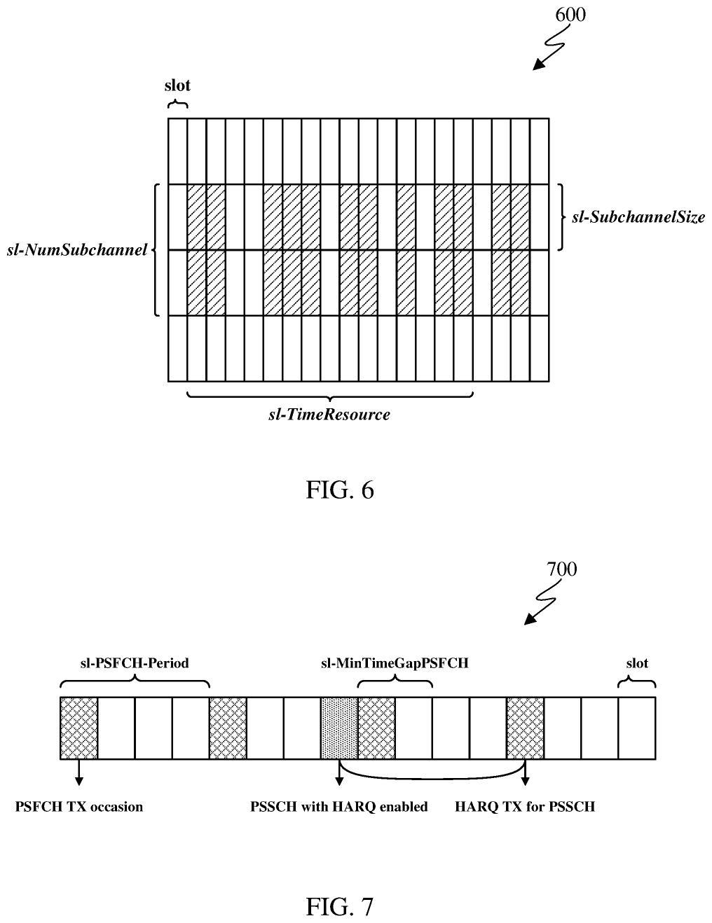

FIG. 6 illustrates a resource pool in Rel-16 NR V2X 600 according to embodiments of the present disclosure. The embodiment of the resource pool in Rel-16 NR V2X 600 illustrated in FIG. 6 is for illustration only. Other embodiments of the resource pool in Rel-16 NR V2X 600 could be used without departing from the scope of this disclosure.

In Rel-16 NR V2X, transmission and reception of sidelink (SL) signals and channels are based on resource pool(s) confined in the configured SL bandwidth part (BWP). In the frequency domain, a resource pool consists of a (pre-)configured number (e.g., sl-NumSubchannel) of contiguous sub-channels, wherein each sub-channel consists of a set of contiguous resource blocks (RBs) in a slot with size (pre-)configured by higher layer parameter (e.g., sl-SubchannelSize). In time domain, slots in a resource pool occur with a periodicity of 10240 ms, and slots including S-SSB, non-UL slots, and reserved slots are not applicable for a resource pool. The set of slots for a resource pool is further determined within the remaining slots, based on a (pre-)configured bitmap (e.g., sl-TimeResource). An illustration of a resource pool is shown in FIG. 6.

Transmission and reception of physical sidelink shared channel (PSSCH), physical sidelink control channel (PSCCH), and physical sidelink feedback channel (PSFCH) are confined within and associated with a resource pool, with parameters (pre-)configured by higher layers (e.g., SL-PSSCH-Config, SL-PSCCH-Config, and SL-PSFCH-Config, respectively).

A UE may transmit the PSSCH in consecutive symbols within a slot of the resource pool, and PSSCH resource allocation starts from the second symbol configured for sidelink, e.g., startSLsymbol+1, and the first symbol configured for sidelink is duplicated from the second configured for sidelink, for AGC purpose. The UE may not transmit PSSCH in symbols not configured for sidelink, or in symbols configured for PSFCH, or in the last symbol configured for sidelink, or in the symbol immediately preceding the PSFCH. The frequency domain resource allocation unit for PSSCH is the sub-channel, and the sub-channel assignment is determined using the corresponding field in the associated SCI.

For transmitting a PSCCH, the UE can be provided a number of symbols (either 2 symbols or 3 symbols) in a resource pool (e.g., sl-TimResourcePSCCH) starting from the second symbol configured for sidelink, e.g., startSLsymbol+1; and further provided a number of RBs in the resource pool (e.g., sl-FreqResourcePSCCH) starting from the lowest RB of the lowest sub-channel of the associated PSSCH.

FIG. 7 illustrates a time domain resource determination for PSFCH 700 according to embodiments of the present disclosure. The embodiment of the time domain resource determination for PSFCH 700 illustrated in FIG. 7 is for illustration only. Other embodiments of the time domain resource determination for PSFCH 700 could be used without departing from the scope of this disclosure.

In time domain, the UE can be further provided a number of slots (e.g., sl-PSFCH-Period) in the resource pool for a period of PSFCH transmission occasion resources, and a slot in the resource pool is determined as containing a PSFCH transmission occasion, if the relative slot index within the resource pool is an integer multiple of the period of PSFCH transmission occasion, and with at least a number of slots provided by sl-MinTimeGapPSFCH after the last slot of the PSSCH reception. PSFCH is transmitted in two contiguous symbols in a slot, wherein the second symbol is with index startSLsymbols+lengthSLsymbols−2, and the two symbols are repeated. An illustration of the time domain resource determination for PSFCH is illustrated in FIG. 7.

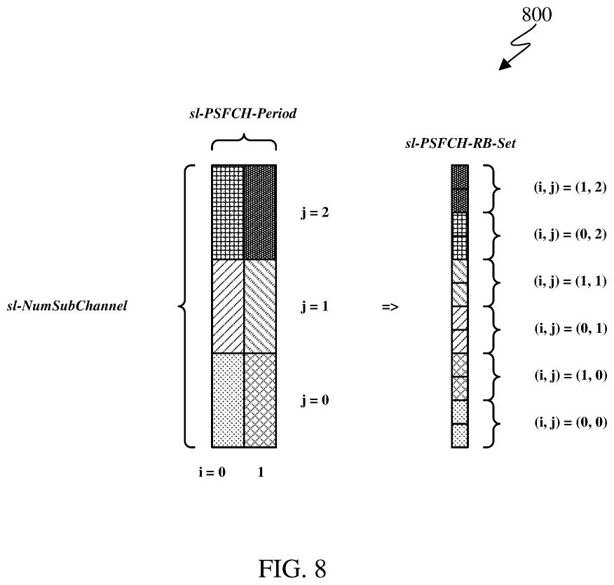

FIG. 8 illustrates frequency domain resource determination for PSFCH 800 according to embodiments of the present disclosure. The embodiment of the frequency domain resource determination for PSFCH 800 shown in FIG. 8 is for illustration only. Other embodiments of the frequency domain resource determination for PSFCH 800 could be used without departing from the scope of this disclosure.

In frequency domain, a PSFCH is transmitted in a single PRB, wherein the PRB is determined from a set of M_{PRB, set}^{PSFCH} PRBs based on an indication of a bitmap (e.g., sl-PSFCH-RB-Set). The UE determines a mapping from slot i (within N_{PSSCH}^{PSFCH} slots provided by sl-PSFCH-Period) and sub-channel j (within N_{subch} sub-channels provided by sl-NumSubchannel) to a subset of PRBs within the set of M_{PRB, set}^{PSFCH}, wherein the subset of PRBs are with index from (i+j·N_{PSSCH}^{PSFCH})·M_{subch, slot}^{PSFCH} to (i+1+j·N_{PSSCH}^{PSFCH})·M_{subch, slot}^{PSFCH}−1, with M_{subch, slot}^{PSFCH}=M_{PRB, set}^{PSFCH}/(N_{subch}·N_{PSSCH}^{PSFCH}). An illustration of this mapping is shown in FIG. 8. The UE determines a number of PSFCH resources available for multiplexing HARQ-ACK information in a PSFCH transmission as R_{PRB, CS}^{PSFCH}=N_{type}^{PSFCH}·M_{subch, slot}^{PSFCH}·N_{CS}^{PSFCH}, wherein N_{type}^{PSFCH} is determined based on the type of resources that the PSFCH is associated with, and N_{CS}^{PSFCH} is a number of cyclic shift pairs for the resource pool provided by sl-NumMuxCS-Pair. The UE determines an index of a PSFCH resource for a PSFCH transmission in response to a PSSCH reception as (P_{ID}+M_{ID}) mod R_{PRB, CS}^{PSFCH}, where P_{ID} is the source ID provided by the SCI scheduling the PSSCH, and M_{ID} is the PSSCH receiver ID in groupcast SL transmission with ACK or NACK information in HARQ-feedback.

Various embodiments of the present disclosure recognize that for sidelink operating with carrier aggregation (CA), there is a need to determine time domain resource allocation for transmission and reception of PSFCH in multiple carriers. Various embodiments and/or examples described for sidelink operating with CA in the present disclosure can be applicable also to operation with a single carrier.

The embodiments and examples in this disclosure can be supported separately or combined. For one instance, enhancement to the time domain resource for PSFCH can be jointly supported with respect to at least one of the enhancement in a slot, the enhancement in a period, or the enhancement across carriers.

For sidelink operation with CA, a UE can be configured with a carrier indicator field by a higher layer parameter, and be based on Uu RRC configuration or PC5 RRC configuration. A DCI format can include the carrier indicator field of 0, 1, 2 or 3 bits, and when not configured the field can be reserved. The carrier indicator can also be included in a SCI-format 1-A, SCI format 2-A or SCI format 2-B.

For the procedure of reporting and obtaining control information in PSFCH and of transmitting PSCCH the UE can determine the set of resources for transmission or reception separately for each carrier using resource pools configured on corresponding carriers. It is possible that a resource pool is shared among carriers and the UE determines resources for transmission and reception from the shared resource pool. Shared resources among carriers can include time resources and/or frequency resources. Subject to higher layer configurations, in one example the UE operating on a first carrier utilizes resources from a pool of resources dedicated to the first carrier in a first time interval and uses resources from a shared pool of resources among first carrier and other carriers in a second time interval. In another example, the shared resources are resources for use of reporting and obtaining control information in PSFCH. In yet another example, the shared resources are resources for use of transmitting or receiving PSCCH.

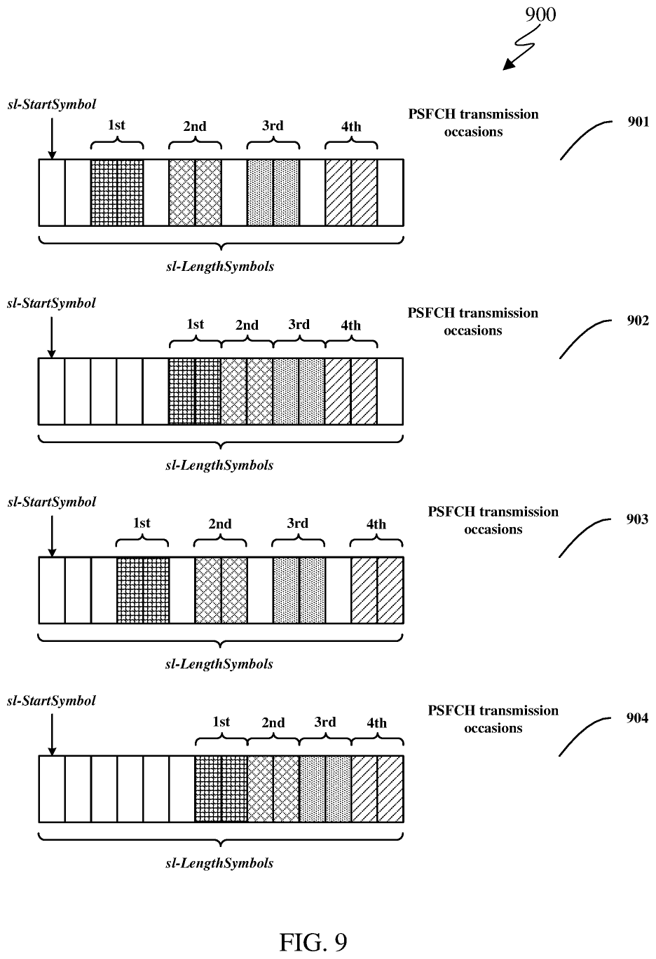

FIG. 9 illustrates an example of PSFCH transmission occasions in a slot 900 according to embodiments of the present disclosure. The embodiment of the example of PSFCH transmission occasions in a slot 900 shown in FIG. 9 is for illustration only. Other embodiments of the example of PSFCH transmission occasions in a slot 900 could be used without departing from the scope of this disclosure.

For sidelink operation with CA, a UE can transmit PSFCH in consecutive PSFCH transmission occasions using different carriers. For example, for two carriers, a first PSFCH transmission occasion in a first slot is on a first carrier and a second PSFCH transmission occasion in a second slot is on a second carrier. It is possible that a first set of PSFCH transmission occasions in a first set of consecutive slots is on a first carrier and a second set of PSFCH transmission occasions in a second set of consecutive slots is on a second carrier, and the second set is after the first set. It is also possible that the set of consecutive PSFCH transmission occasions on one carrier are in non-consecutive slots due to unavailability of one or more slots within the set of slots for PSFCH transmission on that carrier.

When multiple time domain PSFCH transmission occasions can be supported in a slot (denoting the number of time domain PSFCH transmission occasions in a slot as M₂), the UE can use a same carrier for all transmission occasions in the slot and use a different carrier in a subsequent slot, or can use different carriers for different PSFCH transmission occasions in the same slot. The mapping of the PSFCH in one slot may include one or more PSFCH transmission occasions and can be same or different in different carriers or in a set of carriers.

For one example, the location of the one or multiple time domain PSFCH transmission occasions in a slot can be determined based on the symbols pre-configured or configured for sidelink transmission in the slot.
For one instance, the starting symbol of the (m₂+1)th time domain PSFCH transmission occasion in the slot can be determined as S+L−N_{symb}^{PSFCH}·(M₂−m₂), wherein S is the starting symbol for SL resource (e.g., sl-StartSymbol), L is the length of symbols for SL resource (e.g., sl-LengthSymbols), N_{symb}^{PSFCH} is the number of symbols for a PSFCH occasion.
   For one sub-instance, N_{symb}^{PSFCH}=3, and a PSFCH occasion includes 2 consecutive and repeated symbols for PSFCH transmission and 1 symbol reserved as gap. An illustration of this sub-instance is shown in 901 of FIG. 9.
   For another sub-instance, N_{symb}^{PSFCH}=2, and a PSFCH occasion includes 2 consecutive and repeated symbols for PSFCH transmission. An illustration of this sub-instance is shown in 902 of FIG. 9.
For another instance, the starting symbol of the (m₂+1)th time domain PSFCH transmission occasion in the slot can be determined as S+L−N_{symb}^{PSFCH}·(M₂−m₂)+1, wherein S is the starting symbol for SL resource (e.g., sl-StartSymbol), L is the length of symbols for SL resource (e.g., sl-LengthSymbols), N_{symb}^{PSFCH} is the number of symbols for a PSFCH occasion.
   For one sub-instance, N_{symb}^{PSFCH}=3, and a PSFCH occasion includes 2 consecutive and repeated symbols for PSFCH transmission and 1 symbol reserved as gap. An illustration of this sub-instance is shown in 903 of FIG. 9.
For yet another instance, the starting symbol of the (m₂+1)th time domain PSFCH transmission occasion in the slot can be determined as S+L−N_{symb}^{PSFCH}·(M₂−m₂)−1, wherein S is the starting symbol for SL resource (e.g., sl-StartSymbol), L is the length of symbols for SL resource (e.g., sl-LengthSymbols), N_{symb}^{PSFCH} is the number of symbols for a PSFCH occasion.
   For one sub-instance, N_{symb}^{PSFCH}=2, and a PSFCH occasion includes 2 consecutive and repeated symbols for PSFCH transmission. An illustration of this sub-instance is shown in 904 of FIG. 9.

For yet other instances, the starting symbol of the first PSFCH can be the first symbol of the slot, and a PSFCH occasion can include 1 or 2 symbols, and repetitions can be in consecutive or non-consecutive slots, or the AGC symbol(s) is/are in an earlier symbol(s) before the first PSFCH transmission occasion that is with or without repetitions, and subsequent PSFCH transmissions occasions are without repetitions.

A UE can be configured or indicated a single value for each of sl-StartSymbol, sl-LengthSymbols and N_{symb}^{PSFCH}, and based on a mapping rule, the mapping of PSFCH symbols in one carrier can be different from the mapping on another carrier. It is possible that sl-StartSymbol, sl-LengthSymbols and N_{symb}^{PSFCH} are configured or indicated per carrier, or that sl-StartSymbol, sl-LengthSymbols are configured or indicated per carrier and N_{symb}^{PSFCH} is common to all carriers. It is also possible that sl-StartSymbol is provided per carrier and sl-LengthSymbols and N_{symb}^{PSFCH} are same for all carriers. If different values of sl-StartSymbol and sl-LengthSymbols are provided, the starting symbol of the (m₂+1)th time domain PSFCH transmission occasion in the slot can be determined by the same mapping for all carriers, wherein the mapping can be S+L−N_{symb}^{PSFCH}·(M₂−m₂), or S+L−N_{symb}^{PSFCH}·(M₂−m₂)+1, or S+L−N_{symb}^{PSFCH}·(M₂−m₂)−1.

For another example, the location of the one or multiple time domain PSFCH transmission occasions in a slot can be determined based on a bitmap. A bit in the bitmap taking value of 1 refers to a starting location of a corresponding time domain PSFCH transmission occasion, and the total number of bits taking value of 1 is M₂. For sidelink operation with CA, multiple bitmaps can be used where one bitmap is associated to one carrier or is associated to a set of multiple carriers. When a bitmap associated to operation with CA is not (pre-)configured, the bitmap configured for a single carrier can be used for all carriers, or a default bitmap for each or set of or all carriers can be specified.
For one instance, the bitmap is with length same as the number of symbols in a slot.
For another instance, the bitmap is with length same as the number of symbols for SL resources in a slot (e.g., sl-LengthSymbols).
For yet another instance, the bitmap is with length same as the number of instances of PSFCH in a slot.
For yet another instance, the bitmap can be pre-configured.
For yet another instance, the bitmap can be configured by higher layer parameter and be based on Uu RRC configuration or PC5 RRC configuration.
For yet another instance, the bitmap can be provided by a MAC CE.
For yet another instance, the bitmap can be provided by a SCI format or DCI format.

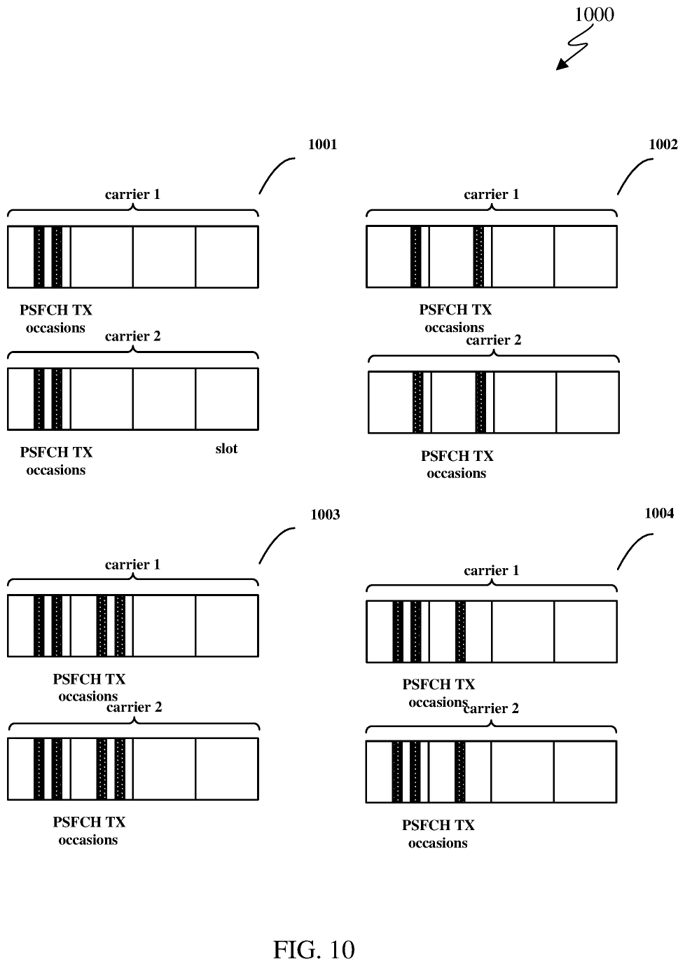

FIG. 10 illustrates an example of PSFCH transmission occasions over a period of 4 slots for two carriers 1000 according to embodiments of the present disclosure. The embodiment of the example of PSFCH transmission occasions over a period of 4 slots for two carriers 1000 shown in FIG. 10 is for illustration only. Other embodiments of the example of PSFCH transmission occasions over a period of 4 slots for two carriers 1000 could be used without departing from the scope of this disclosure.

For sidelink operation with CA, a UE can transmit PSFCH in a first set of PSFCH transmission occasions over a first time interval (or period) on a first carrier and transmit PSFCH in a second set of PSFCH transmission occasions over a second time interval on a second carrier, wherein the first time interval and the second time interval can have same or different duration. The HARQ-ACK feedback in a PSFCH transmission occasion on one carrier can be associated to same or different carrier. Each period may include PSFCH transmission occasions in consecutive or non-consecutive slots, and a slot may include one or multiple PSFCH transmission occasions. A same time domain resource allocation for PSFCH over a period can be used over multiple periods on corresponding multiple carriers, or the time domain resource allocation for PSFCH can be different over periods used by different carriers. It is possible that a pattern of the time domain resource allocation for PSFCH with a periodicity P is used on multiple carriers. For example, a pattern of P periods, p=1, 2, . . . , P, with each period p comprising N slots and corresponding to a mapping of PSFCH transmission occasions. The mapping in each carrier can start from any of the P periods, for example the mapping in the first period of the first carrier can be the mapping of p=i and in subsequent periods of the first carrier can be p=i+1, p=i+2, and so on. For the first period of the second carrier the mapping can be p=j and for subsequent periods can be p=i+1, p=i+2, and so on.

In one embodiment, a combination of time domain (e.g., a slot in a period) and frequency domain (e.g., a sub-channel) resource for PSSCH transmission that enables HARQ feedback transmission can correspond to a PSFCH resource in a number of candidate PSFCH resources periodically showing up in a resource pool, wherein the number of candidate PSFCH resources allocate in one or multiple time domain PSFCH transmission occasions in a period (e.g., denoting the number of time domain PSFCH transmission occasions in a period as M).
For one example, M can fixed in the specification, and can be a default value.
For another example, M can be pre-configured.
For yet another example, M can be configured by higher layer parameter and be based on Uu RRC configuration or PC5 RRC configuration.
For yet another example, M can be provided by a MAC CE.
For yet another example, M can be provided by a SCI format or DCI format.

In one example of this embodiment, the one or multiple time domain PSFCH transmission occasions can be within one slot within the period. An illustration of this example is shown in 1001 of FIG. 10, wherein the first period is on a first carrier and the second period is on a second carrier.
For one instance, the slot index within the resource pool (given by t′ₖ^{SL}) satisfies k mod Nₛₗₒₜ^{PSFCH}=c, wherein c can be same or different for different carriers.
   For one sub-instance, c can fixed in the specification, e.g., c=0.
   For another sub-instance, c can be pre-configured.
   For yet another sub-instance, c can be configured by higher layer parameter, and be based on Uu RRC configuration or PC5 RRC configuration.
   For yet another sub-instance, c can be provided by a MAC CE.
   For yet another sub-instance, c can be provided by a SCI format or DCI format.
For one instance, the location of the time domain PSFCH transmission occasions within the slot can be according to the embodiments and examples in this disclosure.

In another example of this embodiment, the one or multiple time domain PSFCH transmission occasions can be within one or multiple slots within the period, wherein each of the slots includes one-time domain PSFCH transmission occasion. An illustration of this example is shown in 1002 of FIG. 10, wherein the first period is on a first carrier and the second period is on a second carrier.
For one instance, the index of the one or multiple slots within the resource pool (given by t′ₖ^{SL}) satisfies k mod Nₛₗₒₜ^{PSFCH}=c, where c can be one or multiple values determined from a bitmap (e.g., the bitmap is with length same as the number of slots in the period, and a bit taking value of 1 refers to a corresponding slot including a time domain PSFCH transmission occasion, and the total number of bits taking value of 1 is M), and the bitmap can be same or different for different carriers.
   For one sub-instance, the bitmap can be fixed in the specifications, and can be a default value.
   For another sub-instance, the bitmap can be pre-configured.
   For yet another sub-instance, the bitmap can be configured by higher layer parameter, and be based on Uu RRC configuration or PC5 RRC configuration.
   For yet another sub-instance, the bitmap can be provided by a MAC CE.
   For yet another sub-instance, the bitmap can be provided by a SCI format or DCI format.
For another instance, the index of the one or multiple slots within the resource pool (given by t′ₖ^{SL}) satisfies k mod Nₛₗₒₜ^{PSFCH}=c, where c can be one or multiple values determined based on the number of time domain PSFCH transmission occasions in a period (e.g., M). For one sub-instance, c∈{0, . . . , M−1}.

In yet another example of this embodiment, the one or multiple time domain PSFCH transmission occasions can be within one or multiple slots within the period (e.g., denoting the number of slots as M₁), wherein each of the slot includes one or multiple time domain PSFCH transmission occasions (e.g., denoting the number of time domain PSFCH transmission occasions in a slot as M₂). For this sub-example, M₁·M₂=M. An illustration of this example is shown in 1003 of FIG. 10, wherein the first period is on a first carrier and the second period is on a second carrier.
For one instance, M₁ can fixed in the specification, and can be a default value.
For another instance, M₁ can be pre-configured.
For yet another instance, M₁ can be configured by higher layer parameter, and be based on Uu RRC configuration or PC5 RRC configuration.
For yet another instance, M₁ can be provided by a MAC CE.
For yet another instance, M₁ can be provided by a SCI format or DCI format.
For one instance, M₂ can fixed in the specifications, and can be a default value.
For another instance, M₂ can be pre-configured.
For yet another instance, M₂ can be configured by higher layer parameter, and be based on Uu RRC configuration or PC5 RRC configuration.
For yet another instance, M₂ can be provided by a MAC CE.
For yet another instance, M₂ can be provided by a SCI format or DCI format.
For one instance, the index of the one or multiple slots within the resource pool (given by t′ₖ^{SL}) satisfies k mod Nₛₗₒₜ^{PSFCH}=c, where c can be one or multiple values determined from a bitmap (e.g., e.g., the bitmap is with length same as the number of slots in the period, and a bit taking value of 1 refers to a corresponding slot including a time domain PSFCH transmission occasion, and the total number of bits taking value of 1 is M₁).
   For one sub-instance, the bitmap can be fixed in the specifications, and can be a default value.
   For another sub-instance, the bitmap can be pre-configured.
   For yet another sub-instance, the bitmap can be configured by higher layer parameter, and be based on Uu RRC configuration or PC5 RRC configuration.
   For yet another sub-instance, the bitmap can be provided by a MAC CE.
   For yet another sub-instance, the bitmap can be provided by a SCI format or DCI format.
For another instance, the index of the one or multiple slots within the resource pool (given by t′ₖ^{SL}) satisfies k mod Nₛₗₒₜ^{PSFCH}=c, where c can be one or multiple values determined based on M₁. For one sub-instance, c∈{0, . . . , M₁−1}.
For one instance, the location of the time domain PSFCH transmission occasions within the slot can be according to the embodiments and examples in this disclosure.

In yet another example of this embodiment, the one or multiple time domain PSFCH transmission occasions can be within one or multiple slots within the period (e.g., denoting the number of slots as M₁), wherein each of the slot includes one or multiple time domain PSFCH transmission occasions (e.g., denoting the number of time domain PSFCH transmission occasions in a slot as M₂). The M time domain PSFCH transmission occasions are selected from the M₁·M₂ candidate occasions (e.g., selected as the first M occasions, or the last M occasions). An illustration of this example is shown in 1004 of FIG. 10, wherein the first period is on a first carrier and the second period is on a second carrier.
For one instance, M₁ can fixed in the specifications, and can be a default value.
For another instance, M₁ can be pre-configured.
For yet another instance, M₁ can be configured by higher layer parameter, and be based on Uu RRC configuration or PC5 RRC configuration.
For yet another instance, M₁ can be provided by a MAC CE.
For yet another instance, M₁ can be provided by a SCI format or DCI format.
For one instance, M₂ can fixed in the specifications, and can be a default value.
For another instance, M₂ can be pre-configured.
For yet another instance, M₂ can be configured by higher layer parameter, and be based on Uu RRC configuration or PC5 RRC configuration.
For yet another instance, M₂ can be provided by a MAC CE.
For yet another instance, M₂ can be provided by a SCI format or DCI format.
For one instance, the index of the one or multiple slots within the resource pool (given by t′ₖ^{SL}) satisfies k mod Nₛₗₒₜ^{PSFCH}=c, where c can be one or multiple values determined from a bitmap (e.g., e.g., the bitmap is with length same as the number of slots in the period, and a bit taking value of 1 refers to a corresponding slot including a time domain PSFCH transmission occasion, and the total number of bits taking value of 1 is M₁).
   For one sub-instance, the bitmap can be fixed in the specifications, and can be a default value.
   For another sub-instance, the bitmap can be pre-configured.
   For yet another sub-instance, the bitmap can be configured by higher layer parameter, and be based on Uu RRC configuration or PC5 RRC configuration.
   For yet another sub-instance, the bitmap can be provided by a MAC CE.
   For yet another sub-instance, the bitmap can be provided by a SCI format or DCI format.
For another instance, the index of the one or multiple slots within the resource pool (given by t′ₖ^{SL}) satisfies k mod Nₛₗₒₜ^{PSFCH}=c, where c can be one or multiple values determined based on M₁. For one sub-instance, c∈{0, . . . , M₁−1}.
For one instance, the location of the time domain PSFCH transmission occasions within the slot can be according to the embodiments and examples in this disclosure.

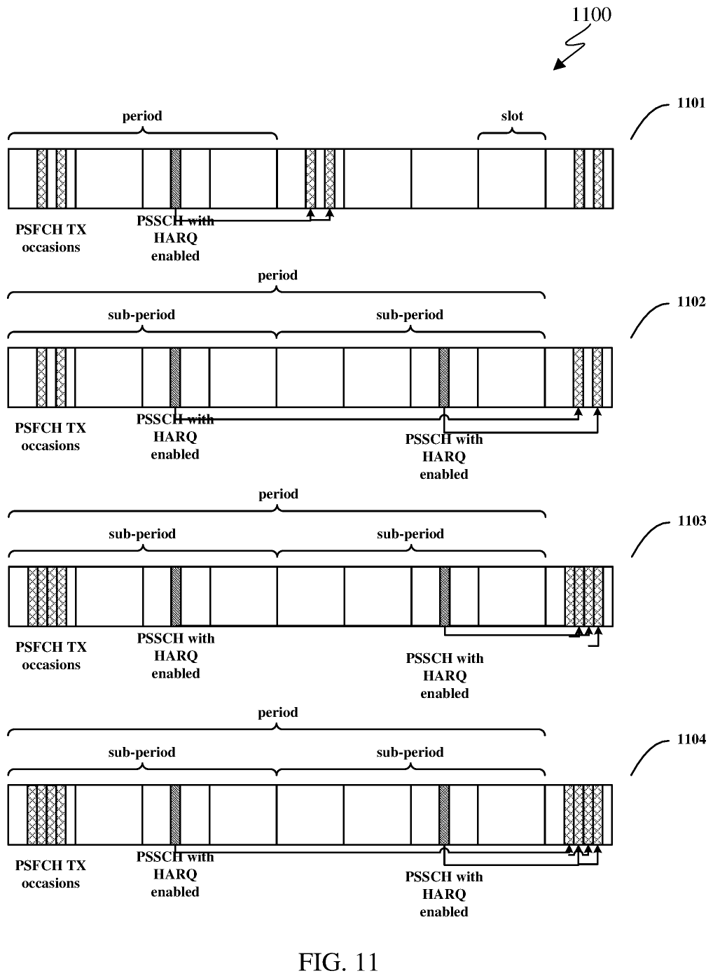

FIG. 11 illustrates an example of PSFCH transmission occasions in a period corresponding to transmission on a carrier of multiple carriers 1100 according to embodiments of the present disclosure. The embodiment of the example of PSFCH transmission occasions in a period corresponding to transmission on a carrier of multiple carriers 1100 shown in FIG. 11 is for illustration only. Other embodiments of the example of PSFCH transmission occasions in a period corresponding to transmission on a carrier of multiple carriers 1100 could be used without departing from the scope of this disclosure.

In one example of this embodiment, the period (e.g., denoted by Nₛₗₒₜ^{PSFCH}) can be pre-configured or configured by higher layer parameter (e.g., sl-PSFCH-Period). An illustration of this example is shown in 1101 of FIG. 11.

In one consideration for this example, a UE determines a number of PSFCH resources available for multiplexing HARQ-ACK information in a PSFCH transmission as R_{TO,PRB,CS}^{PSFCH}=N_{TO}^{PSFCH}·N_{PRB}^{PSFCH}·N_{CS}^{PSFCH}, wherein N_{TO}^{PSFCH} is the associated number of time domain PSFCH transmission occasions with N_{TO}^{PSFCH}=M in this example, N_{PRB}^{PSFCH} is the associated number of frequency domain resources, and N_{CS}^{PSFCH} is the associated number of cyclic shift pairs in code domain. A combination of time domain (e.g., a slot index i within a period) and frequency domain (e.g., a sub-channel with index j) resource for PSSCH transmission that enables HARQ feedback transmission can correspond to a set of time and frequency domain resources for PSFCH transmission occasion, wherein the set of time and frequency domain resources for PSFCH transmission occasion includes time domain resources from all the M PSFCH transmission occasions.
For one instance, the mapping is in the increasing order of i first and j secondary, and the selection of the set of time and frequency domain resources for PSFCH transmission occasion is in the increasing order of time domain PSFCH transmission occasion first and then in the increasing order of frequency domain resources (e.g., consecutive number of PRBs or interlace based PRBs).
For another instance, the mapping is in the increasing order of i first and j secondary, and the selection of the set of time and frequency domain resources for PSFCH transmission occasion is in the increasing order of frequency domain resources (e.g., consecutive number of PRBs or interlace based PRBs) first and then in the increasing order of time domain PSFCH transmission occasion.

In another consideration for this example, the UE can select one of the associated time domain PSFCH transmission occasions to transmit the HARQ feedback for a PSSCH (e.g., subject to channel access procedure on the unlicensed band), and determines a number of PSFCH resources available for multiplexing HARQ-ACK information in a PSFCH transmission as R_{TO,PRB,CS}^{PSFCH}=N_{TO}^{PSFCH}·N_{PRB}^{PSFCH}·N_{CS}^{PSFCH}, wherein N_{TO}^{PSFCH} is the associated number of time domain PSFCH transmission occasions with N_{TO}^{PSFCH}=1 in this example, N_{PRB}^{PSFCH} is the associated number of frequency domain resources, and N_{CS}^{PSFCH} is the associated number of cyclic shift pairs in code domain. A combination of time domain (e.g., a slot index i within a period) and frequency domain (e.g., a sub-channel with index j) resource for PSSCH transmission that enables HARQ feedback transmission can correspond to a set of time and frequency domain resources for PSFCH transmission occasion, wherein the set of time and frequency domain resources for PSFCH transmission occasion includes time domain resources from the selected one of the M PSFCH transmission occasions.
For one instance, the frequency domain resource for PSFCH transmission associated with a combination (i, j) in all the time domain PSFCH transmission occasions is the same.
For another instance, the frequency domain resource for PSFCH transmission associated with a combination (i, j) in the time domain PSFCH transmission occasions can be different. For instance, for the (m+1)th time domain PSFCH transmission occasion can have an offset on the frequency domain resource for PSFCH transmission, wherein the offset is determined based on m.

When the UE operates with CA in an unlicensed band, the UE determines a time domain transmission occasion for a PSFCH transmission in the same carrier of the reception associated with a HARQ feedback included in the PSFCH, and transmits the PSFCH in the determined transmission occasion when the channel access procedure is successful. If the channel access procedure is unsuccessful, the UE may perform the channel access procedure again in a future symbol or slot in the same carrier or in a different carrier, based on a configuration and/or subject to a UE capability. For example, when the UE operates with a first carrier and a second carrier, the UE performs the first channel access procedure on the first carrier and determines the first transmission occasion for the first PSFCH in the first carrier based on whether the channel access procedure is successful or not, and performs the second channel access procedure on the second carrier and determines the second transmission occasion for the second PSFCH in the second carrier based on whether the channel access procedure is successful or not. It is possible that for the transmission of the second PSFCH that includes the HARQ feedback associated with the reception in the second carrier, the UE performs the channel access procedure in both first and second carriers and determines the transmission occasion for the second PSFCH in the carrier where the channel access procedure is successful (and if the channel access procedure is successful on both carriers, the UE transmits the second PSFCH in the second carrier which is the same carrier of the reception associated with the HARQ feedback included in the second PSFCH). It is also possible that the UE performs the channel access procedure in the second carrier which is the same carrier of the reception associated with the HARQ feedback included in the second PSFCH, and if unsuccessful, the UE performs the channel access procedure in the first carrier which is a different carrier than the carrier of the reception associated with the HARQ feedback included in the second PSFCH. It is also possible that, based on a configuration by higher layers, the UE determines the transmission occasion for the first PSFCH transmission and the transmission occasion for the second PSFCH on the first carrier (or on the second carrier) based on the channel access procedure on the first carrier (or on the second carrier, respectively).

In another example of this embodiment, the period (e.g., denoted by Nₛₗₒₜ^{PSFCH}) can be determined as a number of sub-periods, wherein the duration of the sub-period can be pre-configured or configured by higher layer parameter (e.g., sl-PSFCH-Period), and the number of sub-periods within the period can be denoted as Rₛₗₒₜ^{PSFCH}.
For one sub-example, Rₛₗₒₜ^{PSFCH} can fixed in the specification (e.g., Rₛₗₒₜ^{PSFCH}=1, 2, 4, or 8).
For another sub-example, Rₛₗₒₜ^{PSFCH} can be pre-configured (e.g., Rₛₗₒₜ^{PSFCH} is from the set or a subset of {1, 2, 4, 8}).
For yet another sub-example, Rₛₗₒₜ^{PSFCH} can be configured by higher layer parameter (e.g., Rₛₗₒₜ^{PSFCH} is from the set or a subset of {1, 2, 4, 8}).
For yet another sub-example, Rₛₗₒₜ^{PSFCH} can be provided by a MAC CE (e.g., Rₛₗₒₜ^{PSFCH} is from the set or a subset of {1, 2, 4, 8}).
For yet another sub-example, Rₛₗₒₜ^{PSFCH} can be provided by a SCI format (e.g., Rₛₗₒₜ^{PSFCH} is from the set or a subset of {1, 2, 4, 8}).

In one consideration for this example, Rₛₗₒₜ^{PSFCH} =M, and a UE determines a number of PSFCH resources available for multiplexing HARQ-ACK information in a PSFCH transmission as R_{TO,PRB,CS}^{PSFCH}=N_{TO}^{PSFCH}·N_{PRB}^{PSFCH}·N_{CS}^{PSFCH}, wherein N_{TO}^{PSFCH} is the associated number of time domain PSFCH transmission occasions with N_{TO}^{PSFCH}=1 in this example, N_{PRB}^{PSFCH} is the associated number of frequency domain resources, and N_{CS}^{PSFCH} is the associated number of cyclic shift pairs in code domain. The UE assumes a one-to-one mapping between a sub-period within the period and a time domain PSFCH transmission occasion, e.g., the (m+1)th sub-period within the period can be associated with the (m+1)th time domain PSFCH transmission occasion, where 0≤m≤M−1. An illustration of this example is shown in 1102 of FIG. 11. A combination of time domain (e.g., a slot index i within a sub-period) and frequency domain (e.g., a sub-channel with index j) resource for PSSCH transmission that enables HARQ feedback transmission can correspond to a set of time and frequency domain resources for PSFCH transmission occasion, wherein the set of time and frequency domain resources for PSFCH transmission occasion includes time domain resources from the selected one of the M PSFCH transmission occasions.

In another consideration for this example, Rₛₗₒₜ^{PSFCH}=M̅, and a UE determines a number of PSFCH resources available for multiplexing HARQ-ACK information in a PSFCH transmission as R_{TO,PRB,CS}^{PSFCH}=N_{TO}^{PSFCH}·N_{PRB}^{PSFCH}·N_{CS}^{PSFCH}, wherein N_{TO}^{PSFCH} is the associated number of time domain PSFCH transmission occasions with N_{TO}^{PSFCH}=M/M̅ in this example, N_{PRB}^{PSFCH} is the associated number of frequency domain resources, and N_{CS}^{PSFCH} is the associated number of cyclic shift pairs in code domain. The UE assumes a mapping between a sub-period within the period and a set of time domain PSFCH transmission occasions, e.g., the (m̅+1)th sub-period within the period can be associated with the (m̅M/M̅+1)th to (m̅+1)M/M̅th time domain PSFCH transmission occasions, where 0≤m̅≤M̅−1. An illustration of this example is shown in 1103 of FIG. 11. A combination of time domain (e.g., a slot index i within the (m̅+1)th sub-period) and frequency domain (e.g., a sub-channel with index j) resource for PSSCH transmission that enables HARQ feedback transmission can correspond to a set of time and frequency domain resources for PSFCH transmission occasion, wherein the set of time and frequency domain resources for PSFCH transmission occasion includes time domain resources from all the determined M/M̅ PSFCH transmission occasions.
For one instance, the mapping is in the increasing order of i first and j secondary, and the selection of the set of time and frequency domain resources for PSFCH transmission occasion (within the (m̅M/M̅+1)th to (m̅+1)M/M̅th time domain PSFCH transmission occasions) is in the increasing order of time domain PSFCH transmission occasion first and then in the increasing order of frequency domain resources (e.g., consecutive number of PRBs or interlace based PRBs).
For another instance, the mapping is in the increasing order of i first and j secondary, and the selection of the set of time and frequency domain resources for PSFCH transmission occasion (within the (m̅M/M̅+1)th to (m̅+1)M/M̅th time domain PSFCH transmission occasions) is in the increasing order of frequency domain resources (e.g., consecutive number of PRBs or interlace based PRBs) first and then in the increasing order of time domain PSFCH transmission occasion.
For one consideration of this example, for the embodiments and examples in this disclosure with one or multiple time domain PSFCH transmission occasions located within one or multiple slots within the period (e.g., denoting the number of slots as M₁), M̅ can be the same as M₁.
For another consideration of this example, for the embodiments and examples in this disclosure with one or multiple time domain PSFCH transmission occasions located within one slot within the period (e.g., denoting the number of time domain PSFCH transmission occasions as M₂), M̅ can be the same as M₂.

In yet another consideration for this example, Rₛₗₒₜ^{PSFCH}=M̅, and a UE determines a number of PSFCH resources available for multiplexing HARQ-ACK information in a PSFCH transmission as R_{TO,PRB,CS}^{PSFCH}=N_{TO}^{PSFCH}·N_{PRB}^{PSFCH}·N_{CS}^{PSFCH}, wherein N_{TO}^{PSFCH} is the associated number of time domain PSFCH transmission occasions with N_{TO}^{PSFCH}=M/M̅ in this example, N_{PRB}^{PSFCH} is the associated number of frequency domain resources, and N_{CS}^{PSFCH} is the associated number of cyclic shift pairs in code domain. The UE assumes a mapping between a sub-period within the period and a set of time domain PSFCH transmission occasions, e.g., the (m̅+1)th sub-period within the period can be associated with the time domain PSFCH transmission occasion(s) with index(es) m satisfying m mod M/M̅=m̅, where 0≤m̅≤M̅−1. An illustration of this example is shown in 1104 of FIG. 11. A combination of time domain (e.g., a slot index i within the (m̅+1)th sub-period) and frequency domain (e.g., a sub-channel with index j) resource for PSSCH transmission that enables HARQ feedback transmission can correspond to a set of time and frequency domain resources for PSFCH transmission occasion, wherein the set of time and frequency domain resources for PSFCH transmission occasion includes time domain resources from all the determined M/M̅ PSFCH transmission occasions.
For one instance, the mapping is in the increasing order of i first and j secondary, and the selection of the set of time and frequency domain resources for PSFCH transmission occasion (within the time domain PSFCH transmission occasion(s) with index(es) m satisfying m mod M/M̅=m̅) is in the increasing order of time domain PSFCH transmission occasion first and then in the increasing order of frequency domain resources (e.g., consecutive number of PRBs or interlace based PRBs).
For another instance, the mapping is in the increasing order of i first and j secondary, and the selection of the set of time and frequency domain resources for PSFCH transmission occasion (within the time domain PSFCH transmission occasion(s) with index(es) m satisfying m mod M/M̅=m̅) is in the increasing order of frequency domain resources (e.g., consecutive number of PRBs or interlace based PRBs) first and then in the increasing order of time domain PSFCH transmission occasion.
For one consideration of this example, for the embodiments and examples in this disclosure with one or multiple time domain PSFCH transmission occasions located within one or multiple slots within the period (e.g., denoting the number of slots as M₁), M̅ can be the same as M₁.
For another consideration of this example, for the embodiments and examples in this disclosure with one or multiple time domain PSFCH transmission occasions located within one slot within the period (e.g., denoting the number of time domain PSFCH transmission occasions as M₂), M̅ can be the same as M₂.

In one embodiment, a combination of time domain (e.g., a slot in a period) and frequency domain (e.g., a sub-channel) resources for PSSCH transmission that enables HARQ feedback transmission can correspond to a PSFCH resource in a number of time domain PSFCH transmission occasions, wherein the number of time domain PSFCH transmission occasions are allocated across periods for the selection of the combination of time domain (e.g., a slot in a period) and frequency domain (e.g., a sub-channel) resource for PSSCH transmission that enables HARQ feedback transmission. When a UE is configured for sidelink operation with multiple carriers, time resources for PSSCH and corresponding time resources for PSFCH ca be in different periods and periods can be on same or different carriers. This embodiment considers that PSSCH and corresponding PSFCH carrying the HARQ-ACK information are on different carriers, and periods are aligned over different carriers.

For one consideration of this embodiment, for a given PSSCH transmission that enables HARQ feedback, its associated number of time domain PSFCH transmission occasions are a subset of the time domain PSFCH transmission occasions periodically showing up in the periods, wherein in each period, the time domain PSFCH transmission occasion is associated with the PSSCH transmission based a mapping, wherein the PSFCH transmission occasion and the PSSCH are on different carriers.

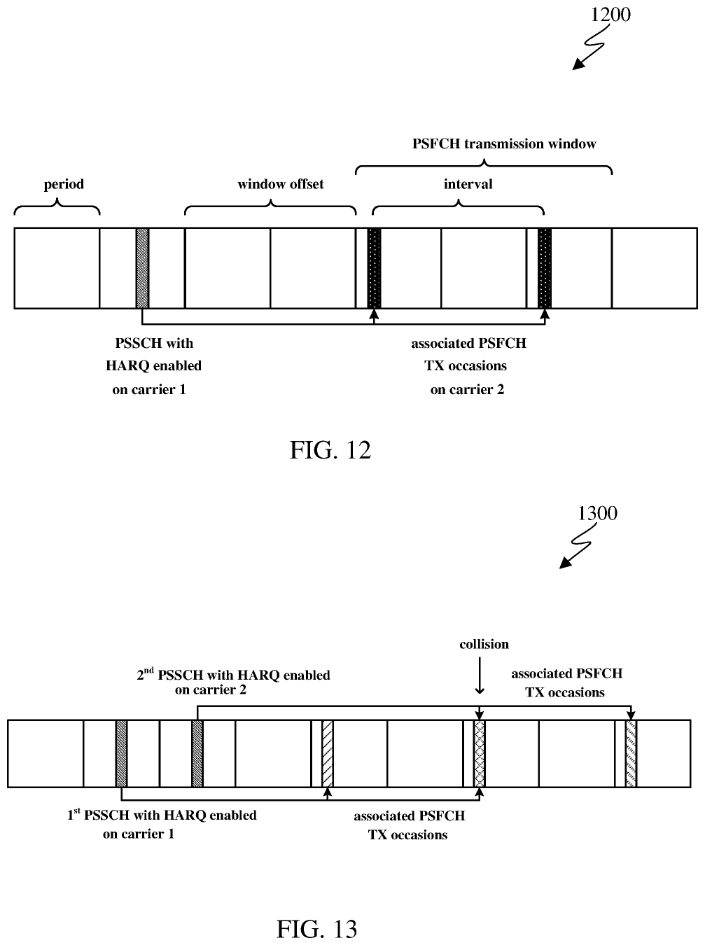

FIG. 12 illustrates an example of physical sidelink shared channel (PSSCH) and corresponding PSFCH with two carriers 1200 according to embodiments of the present disclosure. The embodiment of the example of physical sidelink shared channel (PSSCH) and corresponding PSFCH with two carriers 1200 shown in FIG. 12 is for illustration only. Other embodiments of the example of physical sidelink shared channel (PSSCH) and corresponding PSFCH with two carriers 1200 could be used without departing from the scope of this disclosure.

For another consideration of this embodiment, for a given PSSCH transmission that enables HARQ feedback, its associated number of time domain PSFCH transmission occasions can be within a window, e.g., denoted as PSFCH transmission window, wherein the PSFCH window is on a different carrier than PSSCH when the UE is configured for sidelink operation with multiple carriers. The PSFCH transmission window can be defined using at least one of a periodicity, an offset, a duration, or an interval between two neighboring PSFCH transmission occasions within the window. An illustration of the PSFCH transmission window is shown in FIG. 12.
For one example, at least one of the periodicity of the window, the offset of the window, the duration of the window, or an interval between two neighboring PSFCH transmission occasions within the window can be fixed in the specifications, and can be a default value.
For another example, at least one of the periodicity of the window, the offset of the window, the duration of the window, or an interval between two neighboring PSFCH transmission occasions within the window can be pre-configured.
For yet another example, at least one of the periodicity of the window, the offset of the window, the duration of the window, or an interval between two neighboring PSFCH transmission occasions within the window can be configured by higher layer parameter, and be based on Uu RRC configuration or PC5 RRC configuration.
For yet another example, at least one of the periodicity of the window, the offset of the window, the duration of the window, or an interval between two neighboring PSFCH transmission occasions within the window can be provided by a MAC CE.
For yet another example, at least one of the periodicity of the window, the offset of the window, the duration of the window, or an interval between two neighboring PSFCH transmission occasions within the window can be provided by a SCI format or DCI format.
For one example, the unit of the periodicity of the window can be the period for the defining the mapping between a combination of time domain (e.g., a slot in the period) and frequency domain (e.g., a sub-channel) resource for PSSCH and a PSFCH resource in the period.
For another example, a given PSSCH transmission that enables HARQ feedback can have one associated PSFCH transmission window, and the periodicity of the window is not applicable.
For one example, the unit of the offset of the window can be the period for the defining the mapping between a combination of time domain (e.g., a slot in the period) and frequency domain (e.g., a sub-channel) resource for PSSCH and a PSFCH resource in the period. For one instance, the offset of the window as 0 means the first associated PSFCH transmission occasion locates in the same period as the PSSCH transmission.
For one example, the unit of the duration of the window can be the period for the defining the mapping between a combination of time domain (e.g., a slot in the period) and frequency domain (e.g., a sub-channel) resource for PSSCH and a PSFCH resource in the period.
For another example, the unit of the duration of the window can be a slot.
For yet another example, the duration of the window can be expressed as a number of associated PSFCH transmission occasions.
For one example, the unit of interval between two neighboring PSFCH transmission occasions within the window can be the period for the defining the mapping between a combination of time domain (e.g., a slot in the period) and frequency domain (e.g., a sub-channel) resource for PSSCH and a PSFCH resource in the period. For one instance, the interval can be a period. For another instance, the interval can be a number of periods.
For another example, the unit of interval between two neighboring PSFCH transmission occasions within the window can be a slot.
For one example, the UE can determine the locations of the associated PSFCH transmission occasions based on the at least one of the periodicity of the window, the offset of the window, the duration of the window, or an interval between two neighboring PSFCH transmission occasions within the window. For one further consideration, the first associated PSFCH transmission occasion can be further subject to satisfy a minimum gap duration after the end of the PSSCH transmission.

FIG. 13 illustrates an example of collided PSFCH TX occasions associated to PSSCHs that are transmitted on different occasions 1300 according to embodiments of the present disclosure. The embodiment of the example of collided PSFCH TX occasions associated to PSSCHs that are transmitted on different occasions 1300 shown in FIG. 13 is for illustration only. Other embodiments of the example of collided PSFCH TX occasions associated to PSSCHs that are transmitted on different occasions 1300 could be used without departing from the scope of this disclosure.

For yet another consideration of this embodiment, the associated PSFCH transmission occasions for a first PSSCH transmission on a first carrier can collide with the associated PSFCH transmission occasions for a second PSSCH transmission on a second carrier, wherein the associated PSFCH transmission occasion can be on the first carrier or in the second carrier or in a third carrier. An illustration of this collision is shown in FIG. 13.
In one example, when a UE determines a same PSFCH transmission occasion for the first PSSCH transmission and the second PSSCH transmission, the UE transmits the HARQ feedback information corresponding to the first PSSCH transmission in the PSFCH transmission occasion (e.g., prioritize to transmit the HARQ feedback information corresponding to the earlier PSSCH transmission), and determines another PSFCH transmission occasion for the second PSSCH transmission.
In another example, when a UE determines a same PSFCH transmission occasion for the first PSSCH transmission and the second PSSCH transmission, the UE transmits the HARQ feedback information corresponding to the second PSSCH transmission in the PSFCH transmission occasion (e.g., prioritize to transmit the HARQ feedback information corresponding to the later PSSCH transmission), and determines another PSFCH transmission occasion for the first PSSCH transmission.
In yet another example, when a UE determines a same PSFCH transmission occasion for the first PSSCH transmission and the second PSSCH transmission, the UE transmits the HARQ feedback information corresponding to both PSSCH transmissions in the PSFCH transmission occasion.
   In one sub-example, the UE transmits the HARQ feedback information corresponding to both PSSCH transmissions using a PSFCH format that enables multiple HARQ feedback information bits.
   In another sub-example, the UE multiplexes the HARQ feedback information corresponding to both PSSCH transmissions into the same time domain resources (e.g., in the same time domain PSFCH transmission occasion), and uses different frequency domain resources (e.g., non-overlapping PRBs or non-overlapping interlaces) corresponding to the first and second PSSCH transmissions.
   In another sub-example, the UE multiplexes the HARQ feedback information corresponding to both PSSCH transmissions into the same time domain resources (e.g., in the same time domain PSFCH transmission occasion) and frequency domain resources (e.g., in the same PRBs or interlaces), and uses different cyclic shift pairs corresponding to the first and second PSSCH transmissions.
      For one instance, the different cyclic shift pair can be associated with the period that including the PSSCH transmission. If the index of the period that including the first PSSCH transmission is n₁, and the index of the period that including the second PSSCH transmission is n₂, then the cyclic shift pair corresponding to the first PSSCH transmission is determined based on n₁, and the cyclic shift pair corresponding to the second PSSCH transmission is determined based on n₂.
      For another instance, the different cyclic shift pair can be associated with the index of the PSFCH transmission occasion within all the associated PSFCH transmission occasions. If there are M associated PSFCH transmission occasions for a PSSCH transmission, and the (m₁+1)th PSFCH transmission occasion for the first PSSCH transmission collides with the (m₂+1)th PSFCH transmission occasion for the second PSSCH transmission, then the cyclic shift pair corresponding to the first PSSCH transmission is determined based on m₁, and the cyclic shift pair corresponding to the second PSSCH transmission is determined based on m₂, wherein 0≤m₁≤M−1, and 0≤m₂≤M−1.

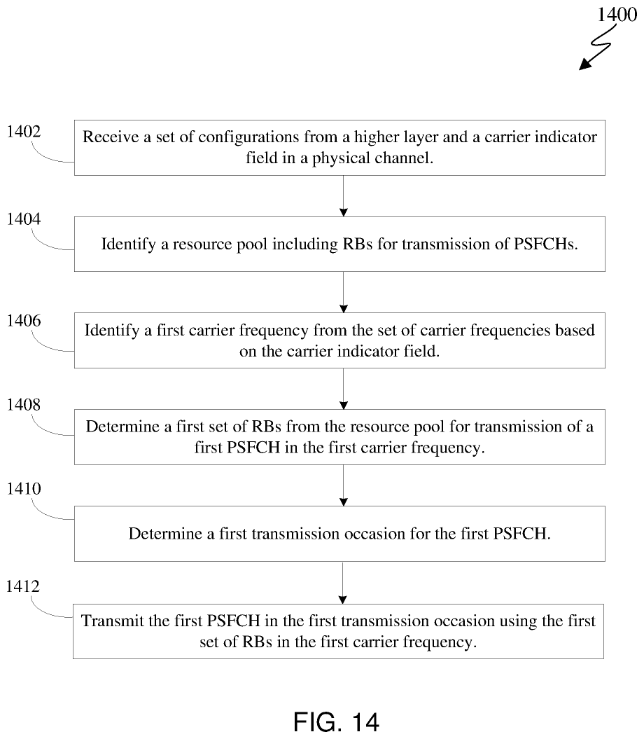

FIG. 14 illustrates an example of a method 1400 for operating a user equipment according to embodiments of the present disclosure. For example, the method 1400 may be performed by any of the UEs 111-116 in FIG. 1. The embodiment of the method 1400 shown in FIG. 14 is for illustration only. Other embodiments could be used without departing from the scope of this disclosure.

The method 1400 begins with the UE receiving a set of configurations from a higher layer and a carrier indicator field in a physical channel (1402). For example, in 1402, the carrier indicator field enables an operation with a set of carrier frequencies.

The UE then identifies, based on the set of configurations, a resource pool including RBs for transmission of PSFCHs (1404). For example, in 1404, the UE determines resource pools including RBs for transmission or reception in corresponding carrier frequencies of the set of carrier frequencies. In one example, the resource pool includes RBs for transmission of more than one PSFCHs in corresponding more than one carrier frequencies of the set of carrier frequencies. In another example, the resource pool includes RBs for transmission or reception of PSSCHs in corresponding more than one carrier frequencies of the set of carrier frequencies.

The UE then identifies, based on the set of configurations, a first carrier frequency from the set of carrier frequencies based on the carrier indicator field (1406). The UE then determines, based on the set of configurations, a first set of RBs from the resource pool for transmission of a first PSFCH in the first carrier frequency (1408). The UE then determines a first transmission occasion for the first PSFCH (1410). The UE then transmits the first PSFCH in the first transmission occasion using the first set of RBs in the first carrier frequency (1402). For example, in 1412, the transmission of the first PSFCH in the first carrier frequency includes a HARQ feedback associated with a physical channel reception in another carrier frequency of the set of carrier frequencies.

In various embodiments, the UE also identifies a second carrier frequency from the set of carrier frequencies based on the carrier indicator field, identifies a second PSFCH including a HARQ feedback associated with a physical channel reception in a second carrier frequency of the set of carrier frequencies, determine a second set of RBs associated with the first carrier frequency from the resource pool for transmission of the second PSFCH, determines a second transmission occasion associated with the first carrier frequency for the second PSFCH, and transmits the second PSFCH in the second transmission occasion using the second set of RBs in the first carrier frequency.

In various embodiments, the UE also determines a second carrier frequency from the set of carrier frequencies based on the carrier indicator field, determines a second transmission occasion for a second PSFCH in a same slot as the first transmission occasion for the first PSFCH, and transmits the second PSFCH in the second transmission occasion in the second carrier frequency. For example, the UE may determine, from the set of configurations, at least one of: a start symbol and a time window duration for transmission of each or both of the first PSFCH and the second PSFCH, symbols for transmission of the first or second PSFCHs based on a bitmap, wherein each bit in the bitmap corresponds to a symbol of the slot, and slots for transmission of the first and second PSFCHs based on a first number of slots indicating a period and a second number of slots indicating consecutive slots for PSFCH transmissions within the period.

In various embodiments, the UE also determines transmission occasions for PSFCHs in corresponding carrier frequencies of the set of carrier frequencies, where the transmission occasions for PSFCHs in corresponding carrier frequencies are in different slots.

In various embodiments, the UE also identifies a second carrier frequency from the set of carrier frequencies based on the carrier indicator field, determines a second transmission occasion for a second PSFCH, performs a SL channel access procedure in the first carrier frequency before determining the first transmission occasion for the first PSFCH and in the second carrier frequency before determining the second transmission occasion for the second PSFCH, transmits the first PSFCH in the first transmission occasion in the first carrier frequency, and transmits the second PSFCH in the second transmission occasion in the first carrier frequency, after performing successfully the SL channel access procedure in the first carrier frequency and unsuccessfully the SL channel access procedure in the second carrier frequency.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a transceiver configured to receive:
a set of configurations from a higher layer, and
a carrier indicator field in a physical channel, wherein the carrier indicator field enables an operation with a set of carrier frequencies; and
a processor operably coupled to the transceiver, the processor configured to:
identify, based on the set of configurations, a resource pool including resource blocks (RBs) for transmission of physical sidelink feedback channels (PSFCHs),
identify, based on the set of configurations, a first carrier frequency from the set of carrier frequencies based on the carrier indicator field,
determine, based on the set of configurations, a first set of RBs from the resource pool for transmission of a first PSFCH in the first carrier frequency, and
determine a first transmission occasion for the first PSFCH,
wherein the transceiver is further configured to transmit the first PSFCH in the first transmission occasion using the first set of RBs in the first carrier frequency.

2. The UE of claim 1, wherein the resource pool includes RBs for transmission of more than one PSFCHs in corresponding more than one carrier frequencies of the set of carrier frequencies.

3. The UE of claim 1, wherein the resource pool includes RBs for transmission or reception of physical sidelink shared channels (PSSCHs) in corresponding more than one carrier frequencies of the set of carrier frequencies.

4. The UE of claim 1, wherein the processor is further configured to determine resource pools including RBs for transmission or reception in corresponding carrier frequencies of the set of carrier frequencies.

5. The UE of claim 1, wherein the transmission of the first PSFCH in the first carrier frequency includes a hybrid automatic repeat request (HARQ) feedback associated with a physical channel reception in another carrier frequency of the set of carrier frequencies.

6. The UE of claim 1, wherein:
the processor is further configured to:
identify a second carrier frequency from the set of carrier frequencies based on the carrier indicator field,
identify a second PSFCH including a HARQ feedback associated with a physical channel reception in a second carrier frequency of the set of carrier frequencies,
determine a second set of RBs associated with the first carrier frequency from the resource pool for transmission of the second PSFCH, and
determine a second transmission occasion associated with the first carrier frequency for the second PSFCH, and
the transceiver is further configured to transmit the second PSFCH in the second transmission occasion using the second set of RBs in the first carrier frequency.

7. The UE of claim 1, wherein:
the processor is further configured to determine:
a second carrier frequency from the set of carrier frequencies based on the carrier indicator field, and
a second transmission occasion for a second PSFCH in a same slot as the first transmission occasion for the first PSFCH; and
the transceiver is further configured to transmit the second PSFCH in the second transmission occasion in the second carrier frequency.

8. The UE of claim 7, wherein the processor is further configured to determine, from the set of configurations, at least one of:
a start symbol and a number of symbols for transmission of each or both of the first PSFCH and the second PSFCH,
symbols for transmission of the first or second PSFCHs based on a bitmap, wherein each bit in the bitmap corresponds to a symbol of the slot, and
slots for transmission of the first and second PSFCHs based on a first number of slots indicating a period and a second number of slots indicating consecutive slots for PSFCH transmissions within the period.

9. The UE of claim 1, wherein:
the processor is further configured to determine transmission occasions for PSFCHs in corresponding carrier frequencies of the set of carrier frequencies; and
the transmission occasions for PSFCHs in corresponding carrier frequencies are in different slots.

10. The UE of claim 1, wherein:
the processor is further configured to:
identify a second carrier frequency from the set of carrier frequencies based on the carrier indicator field,
determine a second transmission occasion for a second PSFCH, and
perform a sidelink (SL) channel access procedure in the first carrier frequency before determining the first transmission occasion for the first PSFCH and in the second carrier frequency before determining the second transmission occasion for the second PSFCH; and
the transceiver is further configured to transmit:
the first PSFCH in the first transmission occasion in the first carrier frequency, and
the second PSFCH in the second transmission occasion in the first carrier frequency after performing:
successfully the SL channel access procedure in the first carrier frequency, and
unsuccessfully the SL channel access procedure in the second carrier frequency.

11. A method of user equipment (UE) in a wireless communication system, the method comprising:
receiving:
a set of configurations from a higher layer, and
a carrier indicator field in a physical channel, wherein the carrier indicator field enables an operation with a set of carrier frequencies;
identifying, based on the set of configurations, a resource pool including resource blocks (RBs) for transmission of physical sidelink feedback channels (PSFCHs);
identifying, based on the set of configurations, a first carrier frequency from the set of carrier frequencies based on the carrier indicator field;
determining, based on the set of configurations, a first set of RBs from the resource pool for transmission of a first PSFCH in the first carrier frequency;
determining a first transmission occasion for the first PSFCH; and
transmitting the first PSFCH in the first transmission occasion using the first set of RBs in the first carrier frequency.

12. The method of claim 11, wherein the resource pool includes RBs for transmission of more than one PSFCHs in corresponding more than one carrier frequencies of the set of carrier frequencies.

13. The method of claim 11, wherein the resource pool includes RBs for transmission or reception of physical sidelink shared channels (PSSCHs) in corresponding more than one carrier frequencies of the set of carrier frequencies.

14. The method of claim 11, further comprising determining resource pools including RBs for transmission or reception in corresponding carrier frequencies of the set of carrier frequencies.

15. The method of claim 11, wherein the transmission of the first PSFCH in the first carrier frequency includes a hybrid automatic repeat request (HARQ) feedback associated with a physical channel reception in another carrier frequency of the set of carrier frequencies.

16. The method of claim 11, further comprising:
identifying a second carrier frequency from the set of carrier frequencies based on the carrier indicator field;
identifying a second PSFCH including a HARQ feedback associated with a physical channel reception in a second carrier frequency of the set of carrier frequencies;
determining a second set of RBs associated with the first carrier frequency from the resource pool for transmission of the second PSFCH;
determining a second transmission occasion associated with the first carrier frequency for the second PSFCH; and
transmitting the second PSFCH in the second transmission occasion using the second set of RBs in the first carrier frequency.

17. The method of claim 11, further comprising:
determining a second carrier frequency from the set of carrier frequencies based on the carrier indicator field;
determining a second transmission occasion for a second PSFCH in a same slot as the first transmission occasion for the first PSFCH; and
transmitting the second PSFCH in the second transmission occasion in the second carrier frequency.

18. The method of claim 17, further comprising:
determining, from the set of configurations, at least one of:
a start symbol and a number of symbols for transmission of each or both of the first PSFCH and the second PSFCH,
symbols for transmission of the first or second PSFCHs based on a bitmap, wherein each bit in the bitmap corresponds to a symbol of the slot, and
slots for transmission of the first and second PSFCHs based on a first number of slots indicating a period and a second number of slots indicating consecutive slots for PSFCH transmissions within the period.

19. The method of claim 11, further comprising:
determining transmission occasions for PSFCHs in corresponding carrier frequencies of the set of carrier frequencies,
wherein the transmission occasions for PSFCHs in corresponding carrier frequencies are in different slots.

20. The method of claim 11, further comprising:
identifying a second carrier frequency from the set of carrier frequencies based on the carrier indicator field;
determining a second transmission occasion for a second PSFCH;
performing a sidelink (SL) channel access procedure in the first carrier frequency before determining the first transmission occasion for the first PSFCH and in the second carrier frequency before determining the second transmission occasion for the second PSFCH;
transmitting the first PSFCH in the first transmission occasion in the first carrier frequency; and
transmitting the second PSFCH in the second transmission occasion in the first carrier frequency, after performing:
successfully the SL channel access procedure in the first carrier frequency, and
unsuccessfully the SL channel access procedure in the second carrier frequency.
